(19) United States
(12) Patent Application Publication
(10) Pub. No.: US 2011/0126681 A1
(43) Pub. Date: Jun. 2, 2011

(54) METHOD FOR SEVERING A PROTRUDING PORTION OF A LAYER OF A LAMINATE

(76) Inventors: Marcel Blanchet, Niederglatt (CH); Roland Kappaun, Uhldingen-Muhlhofen (DE); Walter Zulauf, Ursenbach (CH); Hans-Ulrich Kurt, Kriegstetten (CH); Rudolf Güdel, Solothurn (CH); Rudolf Heid, Luterbach (CH)

(21) Appl. No.: 13/056,126

(22) PCT Filed: Oct. 8, 2009
(86) PCT No.: PCT/CH09/00324

§ 371 Date: Jan. 27, 2011

(30) Foreign Application Priority Data
Oct. 13, 2008 (EP) 08405259.6

(51) Int. Cl. B26D 1/24; B26D 3/00; B26D 5/02; B26D 7/01; B26D 1/18

(52) U.S. Cl. 83/51; 83/500; 83/503; 83/471.2; 83/469

(57) ABSTRACT

In a method for severing a protruding section of a layer of a laminate, particularly a backing film of a laminate, which comprises at least one solid plate, particularly a glass plate, a severing tool having a rotating cutting blade and a rotating counter-blade is used. The blades are rotated in opposite directions about parallel axes. The cutting blade and the counter-blade are furthermore offset laterally such that a main surface of the cutting blade contacts a main surface of the counter-blade in a working region. The offset arrangement of the blades, and the fact that the main surface of the cutting blade and the main surface of the counter-blade mutually contact each other, enable a precise, scissors-like cutting operation, which is particularly suited for severing protruding sections of a laminate. Because the two main surfaces directly abut each other, a jamming of severed material between the blades is prevented.

### TECHNICAL DOMAIN

The invention relates to a method for severing a protruding portion of a layer of a laminate. This is particularly suitable for severing a backing film of a laminate that comprises at least one solid plate, in particular a glass plate. The invention further relates to a severing tool for severing a protruding portion of a layer of a laminate, to a machining station having such a severing tool, and to an installation having such a machining station.

### PRIOR ART

Laminates have a wide range of application, and can have greatly differing layer systems. One group of laminates has one or more solid plates, which impart dimensional stability to the laminate. Frequently, glass plates serve as solid plates, particularly when the laminate is to be wholly or partially transparent. Examples of such laminates are composite glasses, which are used in glazing for automobiles or buildings.

In addition, solar panels (also called solar modules) also constitute a specific application of such laminates. A known practice for the construction of such solar panels is that whereby a plurality of mechanically sensitive solar cells (photovoltaic cells, e.g. silicon-based thick-layer solar cells) are electrically connected to one another and encapsulated in a layer system. The layer system imparts mechanical stability and protects the encapsulated cells against the effects of weathering or mechanical impairment. The layer system can be based, for example, on a glass substrate that is transparent to the relevant components of the solar radiation and on a backing film, between which the solar cells and the electrical connectors connecting them are encapsulated. Films made of EVA (ethylene vinyl acetate) or of another appropriate material are inserted between the said layers, such that the layer system can be laminated together by the action of heat and pressure. The solar cells can be enclosed by a frame.

In the production of such laminates, it is often necessary, following the laminating process, to sever portions of laminating layers or of the backing film that protrude over the solid plate. A plurality of methods are known for this purpose:

Thus, U.S. Pat. No. 4,067,764 (J. S. Walker, W. C. Kittler) describes a solar panel consisting of a glass plate, two PVB layers, between which solar cells are arranged, and of a PET layer, which closes the layer system. The PET layer protrudes over the further layers, such that it can be fastened to a solid base plate made of metal. After the laminating process, the protruding part of the PET layer is cut off. There is no detailed disclosure of the process step of cutting off. It is assumed that the cutting-off is effected manually in a conventional manner, e.g. manually, with the aid of a sharp-bladed knife.

The manual cutting-off of the edge regions is time-consuming, however, and the risk of injury to the personnel is considerable. There are therefore approaches for the use of special tools for cutting off, or for automating this operation:

DE 34 28 547 C2 (Central Glass/Toray Engineering) relates to a cutting device for cutting off an outer border extending beyond the surface region of plate glass layers, being an outer border of an intermediate layer that is made of PVB and arranged between the plate glass layers. A band knife unit, which can be moved along the perimeter of the glass layers, is used for this purpose. In order to prevent the cut-off outer border from becoming tangled in the revolving disks of the band knife unit, the cutting device comprises a slide block having a stripping edge and means for deflecting the cut-off outer border. During the cutting-off operation, the cutting device is guided along the outer edge of the glass plate layers of the laminate.

EP 0 845 440 B1 (Central Glass) relates to a further apparatus for cutting off the edge region of an intermediate layer of a laminated glass plate. The apparatus comprises a robot arm having a robot hand that holds a detachable cutting knife; the cutting knife is moved away from the edge region of the glass plate if a defined resistance force is exceeded.

EP 1 382 441 A1 relates to a method for automatic production of composite glass. In addition to other stations, an installation used for this purpose comprises a station for trimming a PVB intermediate layer. The assembled layer system is transported, maintaining its alignment, into this station, and the trimming is performed by two automated cutting heads. The cutting heads are parts of 6-axes robots. By means of a further cutting head, the protrusion of the PVB layer can be reduced to practically zero. During the cutting-off process, positioning rollers are used to position the two glass plates in relation to one another and relative to the intermediate layer.

EP 0 861 813 B1 (Bottero) relates to a cutting apparatus for cutting off a perimeter portion of a flexible layer that projects over a plate overlaid with the layer, e.g. for trimming intermediate layers in the production of composite glass. The apparatus comprises a motor-driven, rotating cutting disk, and comprises stop means for the perimeter portion, which are arranged tangentially on a perimeter surface of the cutting disk and exert, at the cutting location, a counter-force against the force of the cutting disk. The stop means comprise a rotatable stop disk, the axis of which is oriented obliquely in relation to the axis of the cutting disk.

It has been found that, in certain situations, the existing solutions provide only unsatisfactory cut results. In particular, these solutions are not very suitable for precise severing of the relatively tough backing film of a layer system for a solar panel. In addition, in the production of solid plates, particularly glass plates, size tolerances in the range from 0.5-2 mm are to be expected. If it is necessary for the protruding edge regions to be severed precisely with a predefined distance from the edge of the solid plate, the cutting-off has to be aligned to the edge of the respective plate. Frequently, however, mechanical support on the laminate, such as that proposed in the case of some of the approaches described, is not possible because, after the laminating process, the edge of the solid plate is mechanically detectable only with difficulty, owing to the laterally expanding laminating layers, the differing extents of the layers and/or of the backing film. In addition, in the case of a mechanical support, the achievable working speed is greatly reduced because, in the case of excessively high speeds, the inertia of the respective mechanical system would result in an inability to move the tool away in time, and the tool, and possibly also the laminate, could become damaged.

### PRESENTATION OF THE INVENTION

It is therefore an object of the invention to create a method, appertaining to the technical domain mentioned at the outset, for severing a protruding portion of a layer of a laminate, which method allows a precise cut and a high working speed.

The achievement of the object is defined by the features of claim 1. According to the invention, a severing tool, having a rotating cutting knife and a rotating counter-knife, is used within the scope of the method according to the invention, the knives being made to rotate in opposite directions about parallel axes, and the cutting knife and the counter-knife being offset laterally in such a way that a main surface of the cutting knife contacts a main surface of the counter-knife in a working region.

A severing tool for use in the method according to the invention thus preferably comprises the following elements:
a) a rotating cutting knife,
b) a rotating counter-knife,
c) at least one drive means for rotatably driving the cutting knife and the counter-knife,
   wherein
d) the cutting knife and the counter-knife are mounted about parallel rotational axes,
e) the cutting knife and the counter-knife can be driven in opposite directions, and wherein
f) the cutting knife and the counter-knife are laterally offset in such a way that a main surface of the cutting knife contacts a main surface of the counter-knife in a working region.

The rotating cutting knives are, in particular, circular disks having a full-perimeter cutting edge. Laterally offset in this context means that one of the knives is set back in a direction perpendicular to the main surfaces of the knives (i.e. axially) in such a way that its front main surface only just contacts the rear main surface of the other knife.

The two knives can be driven by a single drive device, an output of one drive being distributed to both knives, or there are two separate drive devices for the two knives, these drive devices, however, being synchronized to one another. The offset arrangement of the knives, and the fact that the main surface of the cutting knife and the main surface of the counter-knife mutually contact one another, allow a precise, scissors-like cutting operation, which is particularly well suited for severing protruding portions of a laminate. Because the two main surfaces are directly adjacent to one another, jamming of severed material between the knives is prevented.

The method according to the invention and the severing tool according to the invention are particularly suited for severing a backing film of a laminate for a solar panel, e.g. made of Tedlar®, protruding portions of a laminating material, e.g. EVA, also being able to be severed in the same working operation.

The method according to the invention and the severing tool are also suitable for other laminates, particularly for composite glasses (which usually do not have a backing film) or for laminates without solid plates. The latter are easily machined by means of the method and the severing tool according to the invention, because these do not require support on the laminate.

Advantageously, the rotational axes of the cutting knife and of the counter-knife are arranged in such a way that a plane running through the two rotational axes runs obliquely in relation to a working direction, an angle between this plane and the working direction preferably being 55-85°, particularly preferably 65-80°.

With this arrangement, the method, or the severing tool, is particularly suited for severing a comparatively tough backing film. For this purpose, the laminate to be machined is advantageously fed with the backing film uppermost, and the counter-knife is arranged at the top in such a way that, before the cutting knife, it comes into contact with a portion of the workpiece that is to be machined. The counter-knife thus acts like a hold-down device for the backing film, before the actual cutting operation is effected between the cutting knife and the counter-knife.

Advantageously, the cutting knife and the counter-knife are advanced to one another in such a way that they are biased against one another in the axial direction. The biasing ensures a reliable contacting of the main surfaces of the cutting knife and counter-knife.

In principle, it is also possible to dispense with biasing if the knives are made so as to be extremely dimensionally stable and are advanced with precision.

Preferably, the rotary motions of the cutting knife and of the counter-knife, and a relative motion between the severing tool and the laminate, are controlled in such a way that a peripheral region of the knives is substantially stationary relative to the protruding portion during the severing operation. In other words, the peripheral speed at the cutting location corresponds exactly to the relative speed of the laminate in relation to the knives. This means that the cutting knife and the counter-knife roll, as it were, on the material. At the same time, there is likewise only a slight relative motion between the mutually contacting main surfaces of the knives, such that the corresponding frictional forces are minimized.

Advantageously, the method according to the invention comprises the following steps, when it is used for machining a laminate comprising a solid plate:
a) Before the laminating step, at least one location marking is applied to the solid plate, and at least one distance value and/or angle value of the solid plate in relation to the location marking is determined.
b) After the laminating step, the protruding portion is severed, the laminate and the severing tool being positioned automatically relative to one another in dependence on the location marking and the at least one distance value and/or angle value.

An installation for machining the laminate comprises, accordingly:
a) a marking station for applying a location marking to the solid plate;
b) a measuring station for determining at least one distance value and/or angle value of the solid plate in relation to the location marking;
c) a laminating station for laminating the laminate, which laminating station is arranged after the marking station and the measuring station; and
d) a machining station comprising a severing tool according to the invention, the severing tool and the laminate being automatically positionable relative to one another in dependence on the location marking and the at least one distance value and/or angle value.

The machining station preferably comprises a camera, for acquiring the location marking.

More detailed information on these method steps and the corresponding installation are disclosed by EP 08 405 137.4, filed on May 16, 2008, of the applicant of the present application. In particular, the method and the apparatus disclosed here constitute a preferred possible realization for machining of the laminate effected within the scope of the method of EP 08 405 137.4.

Alternatively, the edges can be determined in another manner, and the tool controlled in another manner. In the case of laminates without a solid plate, in which all layers can be cut through, the desired course of cut can, for example, be fixedly predefined so as to be identical for all workpieces.

Preferably, the rotational axis of the cutting knife and/or the rotational axis of the counter-knife is/are realized so as to be adjustable, in particular automatically adjustable, in such a way that a distance of the rotational axis of the cutting knife and of the rotational axis of the counter-knife is adjustable. This allows, on the one hand, exact setting of new knives, or for knives of differing diameter to be received. On the other hand, readjustment of the two knives is allowed, this being necessary, for example, because of wear or after resharpening of the knives.

The severing tool according to the invention is used, in particular, in a machining station, for the purpose of severing a protruding portion of a layer of a laminate. This machining station can constitute part of a machining line for the production of a laminate, which machining line also comprises, for example, a station for laminating, as well as further machining stations.

Advantageously, the machining station for severing a protruding portion of a layer of a laminate comprises
a) a holding means, in particular a table, for holding the laminate,
b) a linear unit, which can be moved along the laminate held in the holding means, and
c) a severing head, on which the cutting knife and the counter-knife are arranged, the severing head being mounted on the linear unit.

The holding means allows stable fixing of the laminate for the machining operation. The linear unit allows rapid linear motions of the severing head relative to the laminate, and therefore a rapid machining operation.

Advantageously, the severing head is movably mounted on the linear unit in such a way that it can be moved horizontally in a direction perpendicular to the direction of motion of the linear unit. The severing head is arranged, for example, on a linear axis that extends in the manner of a bridge over the workpiece and that, for its part, can be moved over the workpiece by the linear unit. In addition to the first linear axis of motion, which is provided by the linear unit, there is thus also a second linear axis of motion for the severing head. This allows the knife arranged on the severing head to be positioned flexibly relative to the outside edge of the laminate to be machined.

Advantageously, in addition, the severing head is realized in such a way that the cutting knife and the counter-knife are mounted, in respect of the linear unit, so as to be rotatable about an axis that is perpendicular to a main surface of the laminate to be machined. Together with the linear unit and the mounting of the severing head that is movable in the transverse direction, this allows rectangular laminates held in the holding means to be machined along all four edges without the need to reposition the laminate. For this purpose, in the corners of the laminate, the severing head is rotated by 90° about the vertical axis in each case and the linear motion is effected alternately by the linear unit and the linear axis arranged transversely thereto.

Alternatively, the severing head has fewer degrees of freedom. The missing degrees of freedom can be realized as part of a movable workpiece holder, or operations to reposition the workpiece (e.g. by means of a handling robot) are performed during the machining.

In a preferred embodiment, the severing head has at least two servo drives. Via coaxial shafts, these servo drives effect driving of the cutting knife and of the counter-knife and effect an adjustment of the rotational position of the cutting knife and of the counter-knife about the vertical axis. The use of two coaxial shafts (at least one of the shafts being realized as hollow shafts) allows both servo drives, namely, also that for driving the knives, to be accommodated in the rotationally fixed part of the severing head. Instead of one servo drive, two separate (but, advantageously, synchronized) drives can also be used to drive the two knives, which drives effect driving of the knives via respective coaxial shafts.

Advantageously, the severing head also comprises a third (or fourth) servo drive, which, via a further coaxial shaft, allows a relative adjustment of the rotational axis of the cutting knife and of the rotational axis of the counter-knife. Thus, this drive also can be arranged on the rotationally fixed part of the severing head.

Alternatively, the relative adjustment of the rotational axes, which is normally necessary only periodically, is effected manually.

In the case of a preferred embodiment, the machining station comprises a sharpening station, which is arranged in such a way that it can be automatically started by the severing head for the purpose of sharpening the cutting knife and the counter-knife. The sharpening can thus be performed in a fully automatic manner, for example whenever it is identified that the cutting result is deteriorating or if abrasion wear of a certain order of magnitude is detected through an (automatic) optical check. Optionally, the sharpening operation can also be initiated manually, but with the further steps being effected in a fully automatic manner.

Alternatively, the sharpening is effected in a known manner, e.g. in that the knives are separated manually from the severing head and replaced by new or reground knives.

In the case of a preferred embodiment, the machining station comprises a tray for collecting cuttings, and a transport means for taking away the collected cuttings. This allows a fully automatic removal of the waste produced during the severing operation.

Further advantageous embodiments and feature combinations of the invention are disclosed by the following detailed description and the totality of the claims.

### BRIEF DESCRIPTION OF THE DRAWINGS

The drawings used to explain the exemplary embodiment show:

FIGS. 1A, B cross-sectional representations of a severing head according to the invention;

FIG. 1C a front view of the severing head;

FIG. 1D an oblique image of the severing head;

FIG. 2 a schematic cross-sectional representation of the severing operation according to the invention;

FIG. 3 an oblique image of a machining station according to the invention;

FIGS. 4A-C two lateral views and a top view of the machining station; and

FIG. 5 an enlarged portion from the oblique image of the machining station.

In principle, in the figures, parts that are the same are denoted by the same references.

### MODES OF REALIZATION OF THE INVENTION

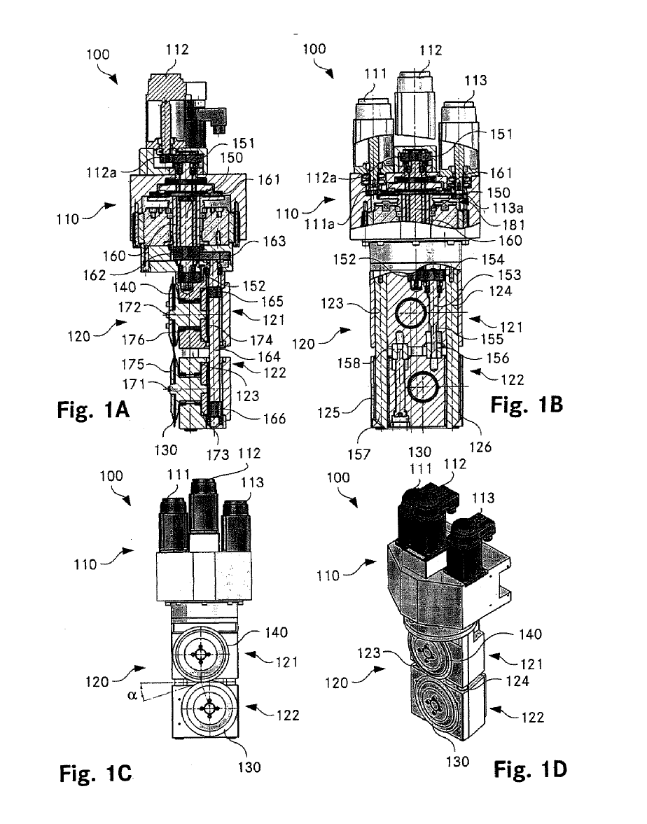

FIGS. 1A, 1B are cross-sectional representations of a severing head 100 according to the invention, FIG. 1D shows a front view, and FIG. 1C shows an oblique view of the severing head 100.

The severing head comprises an upper portion 110, on which three servo drives 111, 112, 113 are arranged, and comprises a lower portion 120 that is rotatable, in respect of the upper portion 110, about a vertical axis. The lower portion 120, in turn, comprises an upper part 121 and a lower part 122 that is vertically displaceable in relation thereto, which have their own housing. To enable the relative displacement, two cylindrical guide rods 123, 124 are screw-connected at one of their ends in the upper part 121 of the lower portion 120. They extend vertically downwards, and their front portions are received in corresponding cylindrical receivers 125, 126 of the lower part 122. The receivers 125, 126 constitute a sleeve bearing for the guide rods 123, 124.

Rotatably mounted in the lower part 122 of the lower portion 120 is a cutting knife 130, and, in the upper part 121, a counter-knife 140. The cutting knife 130 and the counter-knife 140 are realized, in the form of disks, from HSS steel, and have a circular shape with a diameter of 160 mm. Cutting edges are realized on the perimeter. The rotational axes of the two knives are parallel to one another, but laterally offset in respect of the vertical. At the meeting point of the two knives that is at the front in the direction of working, and which is vertically beneath the rotational axis of the counter-knife 140, an angle α between the tangents of the cutting edges is 17.5°. The distance of the two knives, and thereby also this cutting angle, can be altered by adjusting the two parts 121, 122 in relation to one another. The mutual adjustment capability also allows readjustment of the distance between the two knives after a sharpening operation or a knife exchange.

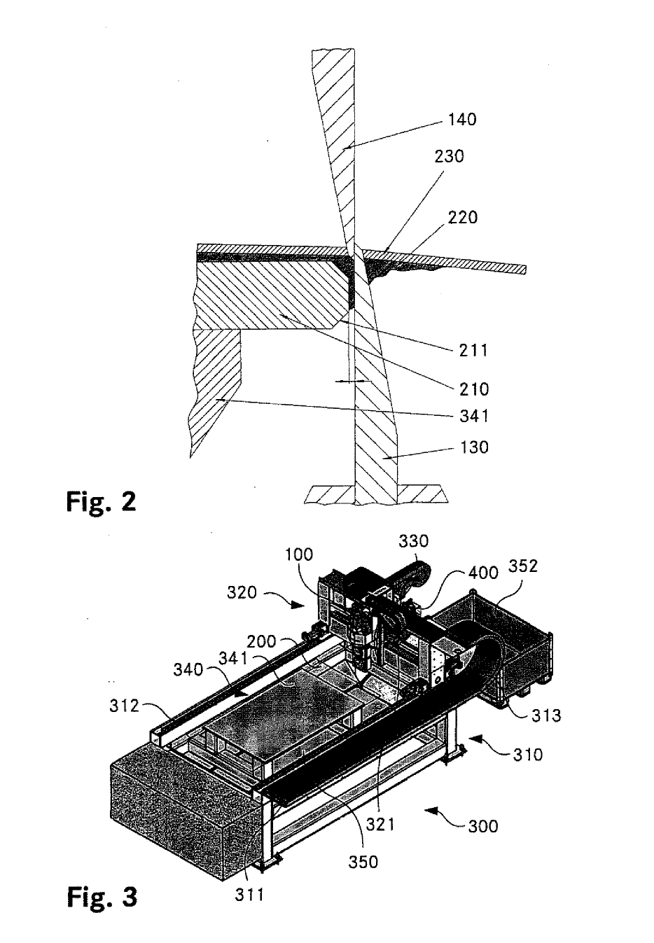

As is clearly visible in FIGS. 1A and 2, in the region of the meeting point a perimeter region of the rear main surface of the counter-knife 140 contacts a corresponding perimeter region of the front main surface of the cutting knife 130, i.e. the counter-knife 140 is arranged in front of the cutting knife 130 in the axial direction. The two knives have a slight mutual bias, such that the contact between the said main surfaces is always maintained.

The centrally arranged servo drive 112 is displaced slightly forwards relative to the two lateral servo drives 111, 113. Its drive pinion 112a acts upon a shaft 150 via a further pinion 151. At its lower end, this shaft has a further pinion 152, which engages with a further pinion 154 arranged on a further shaft 153. At its lower end, the further shaft 153 is provided with an external thread 155, which acts together with an internal thread of a nut 156 that is fixedly connected to the lower part 122. By means of the servo drive 112, the lower part 122 can thus be adjusted in the vertical direction in respect of the upper part. A third shaft 157 is rotatably received in the lower part 122. At its upper end, it has an external thread, which acts together with an internal thread of a nut 158 that is fixedly arranged on the upper part 121.

In the embodiment represented, the third shaft 157 is freely rotatable, and provides only a stop. Alternatively, however, it is possible to dispense with the central servo drive 112, and the distance of the two parts 121, 122 of the lower portion 120 is effected by turning the third shaft 157, which, for this purpose, has a key profile (e.g. a hex key profile) at its lower end that is accessible from the outside.

The drive pinion 111a of the servo drive 111 arranged on the left in FIG. 1B acts together with a pinion 161, which is connected to a hollow shaft 160 in a rotationally fixed manner. The previously mentioned shaft 150 is partially received in the hollow shaft 160. At the lower end of the hollow shaft 160, a further pinion 162 is connected to the hollow shaft 160 in a rotationally fixed manner. This pinion acts upon a pinion 163 of a further, vertically extending shaft 164. This shaft 164 carries two further pinions 165, 166, which act together with crown wheels 173, 174 of the two knife carriers 171, 172 in such a way that these are driven in opposite directions. The knife carriers 171, 172 mounted in rolling bearings are connected to the crown wheels 173, 174 in a rotationally fixed manner. On their front side, which projects over the housing, they each comprise a radially widening portion that constitutes a clamping surface for the respective knife. In this portion, there are four threaded holes, and a central centering pin. The cutting knife is provided with four openings that correspond to the arrangement of the threaded holes, and with a central opening that can act together with the centering pin. The respective knife can thus be securely fastened to the knife carrier 171, 172 by means of a fastening plate 175, 176, which likewise has four openings. The fact that the pinions 165, 166 arranged on the further shaft 164 act together with the crown wheels 173, 174 enables the two knife carriers 171, 172 to be driven in spite of their being arranged in a laterally offset manner in respect of the rotational axis of the shaft 164 and irrespective of the current vertical distance of the two rotational axes.

The drive pinion 113a of the servo drive 113 arranged on the right in FIG. 1B acts upon a reduction gearset 181 having a hollow shaft of the type RV-C of the firm Teijin Seiki Boston Inc. Its output gear wheels are rotatably mounted in the lower portion 120 of the severing head 100. The lower portion 120, in turn, is rotatably mounted in the upper portion 110. By means of the servo drive 113, the lower portion 120 can thus be rotated, relative to the upper portion 110, about a vertical axis.

FIG. 2 is a schematic cross-sectional representation of the severing operation according to the invention. The laminate 200 to be machined comprises a glass plate 210 of single-layer safety glass, which, at its outer edge, is provided with facets 211 on both sides in the usual manner. Connected to the glass plate 210 via a laminate intermediate layer 220 of EVA is a backing film 230 of polyvinyl fluoride (PVF), which is commercially available as Tedlar® PV2010 of the firm DuPont. The backing film 230 has a thickness of 0.35 mm, the laminate intermediate layer 220 has a thickness of approximately 0.2-0.3 mm. It is clearly evident that, in the unmachined state, the backing film 230 projects considerably over the glass plate 210, and that the laminate intermediate layer 220 has an irregular edge.

Also evident from FIG. 2 are the cross-sections of the cutting knife 130 and of the counter-knife 140. The mutually contacting main surfaces are flat and vertically aligned, while the respectively opposite main surfaces in the outer region taper conically, so as to constitute cutting edges.

For the purpose of machining, the laminate 200 is placed, with the glass plate 210 downwards, onto a carrier plate 341, but with the edge regions of the glass plate projecting over the carrier plate 341 (see below). The severing head comprising the cutting knife 130 and the counter-knife 140 is then moved onto the laminate 200 to be machined, in such a way that the backing film 230, together with the laminate intermediate layer 220, can be cut off at a predetermined distance from the outer edge of the glass plate 210. Owing to the laterally offset arrangement of the two knives (see FIG. 1C), the backing film 230 is contacted first by the counter-knife 140, on the side facing away from the glass plate 210 (i.e. free side), the counter-knife 140, with a straight cut run-in, first acting primarily as a hold-down device. The actual severing operation, which is performed in a scissor-like manner, is then effected between the cutting knife 130 and the counter-knife 140. The facet 211 on the contact surface between the glass plate 210 and the backing film 230 enables the knives to be positioned in such a way that the counter-knife 140, which, owing to the radially offset arrangement of the two knives, is closer to the glass plate 210, can be so positioned that its cutting edge reaches as far as into the region of the laminate intermediate layer 220. The cutting edge of the cutting knife 130, for its part, reaches upwards as far as beyond the backing film 230.

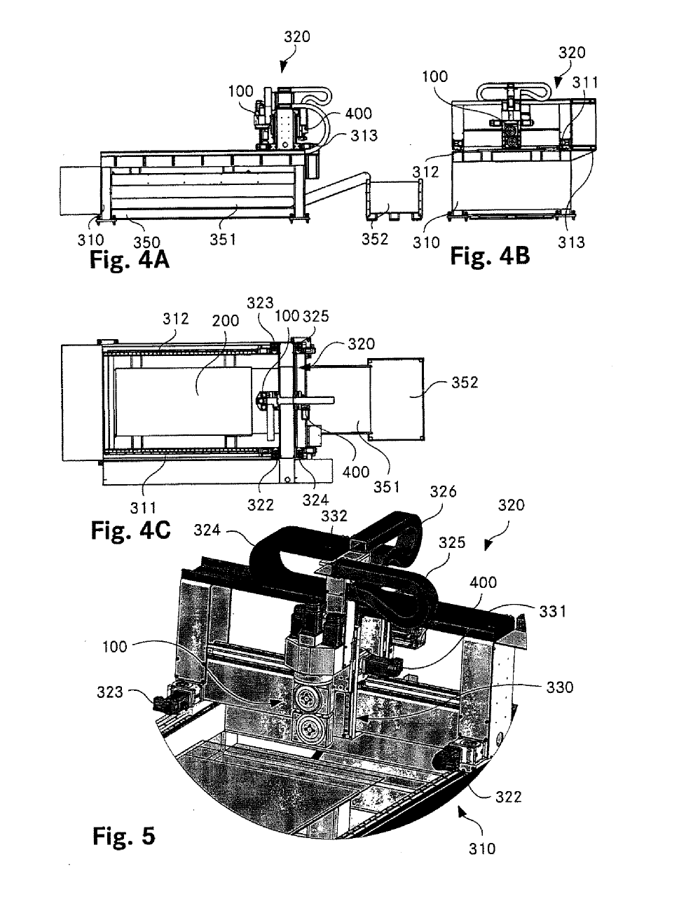

FIG. 3 shows an oblique image of a machining station according to the invention. Represented in FIGS. 4A-C are two lateral views and a top view of the machining station. The machining station 300 comprises a machine frame 310 constructed from aluminum profiles and having two lateral linear guides 311, 312. On these linear guides 311, 312, a bridge 320 is guided so as to be displaceable in the longitudinal direction. The bridge 320 comprises a further linear guide 321, on which a carriage 330 is arranged so as to be displaceable transversely relative to the machine frame 310. A severing head 100, as previously described in connection with FIGS. 1A-D, is arranged so as to be vertically displaceable on the carriage 330. In addition, a milling head 400 is likewise arranged so as to be vertically displaceable on the back side of the bridge 320. The drives present on the bridge 320 are supplied and controlled via an energy chain 313, which is arranged laterally next to one of the linear guides 311 on the machine frame 310. The bridge 320 comprising the severing head 100 is described in greater detail further below, in connection with FIG. 5.

Between the two linear guides 311, 312 arranged on the machine frame 310, the machining station 300 comprises a table 340 having a carrier plate 341 of aluminum, onto which the laminate 200 to be machined can be placed. The carrier plate 341 comprises a vacuum means, known per se, for holding the workpiece. The table 340 is fastened on cross members extending between the longitudinal members of the machine frame 310. Beneath the table 340 there is a tray 350, which receives cuttings produced during the machining process. Running within the tray is a conveyor belt 351, which can transport the cuttings rearwards out of the tray 350. A collecting container 352 is positioned in the extension of the tray 350.

FIG. 5 shows an enlarged portion from the oblique image of the machining station. Arranged on the bridge, for the purpose of longitudinal movement of the bridge 320 on the machine frame 310, are two servo drives 322, 323, which each act, via a pinion, upon a toothed rack extending along the machine frame 310. The two servo drives 322, 323 are electronically synchronized to one another via the machine controller. Two further servo drives 324, 325, which likewise act upon the same toothed racks via pinions, are arranged on the same, behind the bridge 320 (see FIG. 4C). The fact that the servo drives 322, 324; 323, 325 respectively act together upon the same toothed rack, enables the bridge 320 to be fixed on the machine frame 310 in a stable and positionally accurate manner for corresponding machining operations.

Two further servo drives 331, 332 are arranged on the carriage 330. The first servo drive 331 acts, via a pinion, upon a transversely extending toothed rack arranged on the bridge 320. The second servo drive 332 serves to adjust the height of the severing head 100 relative to the carriage 330 via a corresponding ball roller spindle. The milling head 400 on the back side of the bridge 320 is arranged analogously on the carriage 320, and its height can thus be adjusted relative to the carriage 320, independently of the severing head 100. The drives arranged on the carriage 320 and on the severing head 100 or milling head 400 are supplied and controlled via three further energy chains 324, 325, 326.

The severing head can thus be moved, in respect of the machine frame 310, in a program-controlled manner in the X, Y and Z direction in a Cartesian linear system. The cutting head provides three further servo axes (rotation about Z axis, relative adjustment, knife drive).

The machining station according to the invention can be operated, in particular, as follows. First, the laminate 200 is placed onto the carrier plate 341 of the table 340. e.g. by means of an industrial robot having suction grippers. The laminate is held on the carrier plate 341 by the vacuum means.

The position and alignment of the glass plate are then determined. This can be effected, in particular, by a method such as that disclosed by EP 08 405 137.4, filed on May 16, 2008, of the applicant of the present application. Within the scope of this method, the following steps are performed:
a) before the laminating step, at least one location marking is applied to the glass plate, and at least one distance value and/or angle value of the solid plate in relation to the location marking is determined;
b) after the laminating step, the laminate is machined, the laminate and the machining tool being positioned automatically relative to one another in dependence on the location marking and the at least one distance value and/or angle value.

The distance value and/or angle value is stored, in particular, in a central database. In addition, the stored values advantageously include all information required for a definition of the contour of the glass plate that is sufficiently accurate for the process to be performed. The applied markings are then acquired, in particular optically, at the start of the severing operation, and the acquired data concerning the geometry of the glass plate of the laminate is retrieved from the database. The optical acquisition can be effected by means of one or more cameras, which are attached to the bridge 320 or otherwise to the machining station 300. The exact positioning and alignment of the laminate 200 on the carrier plate 341 is therefore not critical. It is important only that it projects on all four sides beyond the carrier plate 341, in order that the edge can be machined.

The carrier head is then guided onto the laminate 200 by means of the corresponding servo drives, in the extension of the first edge to be machined. The positioning, the distance from the laminate 200 and the alignment of the knives is effected by means of the acquired markings and the retrieved data concerning the glass plate 341. A distance of 0.2-0.5 mm between the cutting edge and the edge of the glass plate 341 has proved to be suitable. The first edge is then machined, the severing head 100 being guided in a straight line in the machining direction by means of the longitudinally and transversely extending linear guides. It is to be noted that, usually, the machining direction is followed neither accurately in the longitudinal direction nor accurately in the transverse direction because, on the one hand, the laminate 200 is not aligned exactly on the carrier plate 341 and, on the other hand, because the glass plate of the laminate is usually not exactly rectangular. Owing to the two linear axes working together, and the fact that the lower part of the severing head can be turned in any way, however, it is possible to machine edges that run obliquely. Since changes in the machining direction are also possible at any time, laminates of greatly differing shape (e.g. triangular, hexagonal or round laminates) can be machined. A limit actually exists only in the case of laminates having concave outer edges, if the latter have less than a certain radius of curvature (which is dependent on the design of the severing head).

During the cutting operation, the counter-knife 140 serves primarily as a hold-down device for the backing film 230, while the cutting knife 130 effects the actual severing operation in a scissor-like manner by acting together with the counter-knife 140. The opposing direction of motion of the two knives—as mentioned above—is synchronized mechanically. In addition, it is matched to the linear motion of the severing head 100 in such a way that the knives roll (again in a scissor-like manner) on the workpiece to be machined, i.e. that no tangential relative motion occurs between the knives and the backing film 230, or the laminate intermediate layer 220.

After machining of the first edge, the severing head 100 is rotated by approximately 90° and repositioned, such that the second edge can be machined. This operation is repeated until the backing film and the laminate intermediate layer on all outer edges have been severed.

These method steps can be performed within a short period, a working speed of more than 2 m/s being achievable. Because of the milling head 400 arranged on the back side of the bridge 320, a milling operation can therefore then be performed in the same machining station, particularly in order to expose contact locations present in the laminate, in the case of production of solar panels, by a method such as that disclosed by EP 08 405 123.4, filed on Apr. 30, 2008, of the applicant of the present application. Within the scope of this method, the following steps are performed:
a) before the laminating step, solar cells are connected by electrically conductive connectors,
b) the electrically conductive connectors being inserted in the solar panel to be laminated in such a way that, after the laminating step, they are completely laminated into the solar panel.
c) After the laminating step, a contact region of the electrically conductive connector is exposed, in that at least one of the layers (in particular the backing film) covering the solar cells is completely perforated, in particular removed.
d) The contact region of the electrically conductive connectors is contacted by means of a connecting element that can be tapped from the outside.

In particular, step c) of this method can be performed on the machining station according to the invention.

Wastes produced during the machining fall into the tray 350 and are conveyed into the container 352 by the conveyor belt 351. Finally, the machined laminate is taken back off the carrier plate 341, in particular again by a correspondingly programmed industrial robot.

A sharpening station (not represented here) can be provided in a corner of the machining station 300. If it is ascertained, e.g. by means of a laser measuring device for monitoring fracturing of the cutting edge, that the cutting edge is blunt or has scores, the severing head 100 is moved to the sharpening station by means of the corresponding linear axes. The mutually opposite servo drives 322, 324 and 323, 325 then act together to position the bridge 320 accurately and without play. (In an alternative embodiment, the bridge is moved to a fixed stop by means of only one drive in each case). The sharpening is effected using known means, e.g. by means of grinding disks driven in rotation, the two knives also being able to be driven by means of the servo drive 111 during the sharpening operation. After the sharpening operation, the distance of the two knives is automatically readjusted by means of the servo drive 112, such that the desired cutting angle is maintained. The resharpening of the two knives can thus be effected without demounting the latter.

The invention is not limited to the exemplary embodiment represented. Thus, in particular, the structural realization of the principle according to the invention can be effected in another manner. Thus, in particular, the degrees of freedom of the two knives in respect of the laminate to be machined can be realized differently; for example, if a turntable is provided and the distance of the lateral linear guides is sufficiently great, it is possible to dispense with the arrangement whereby the blades on the severing head are rotatable about the vertical axis. Analogously, in principle, instead of the severing head, the workpiece carrier can also be realized so as to be vertically movable. Moreover, it is also conceivable for the linear motions necessary for the machining to be caused by motions of the workpiece, and not of the tool. The arrangement of the milling head on the bridge is optional. If such a milling operation has to be performed at all, it can also be effected in a separate machining station.

In summary, it is to be stated that, through the invention, there is created a method for severing a protruding portion of a layer of a laminate, which method allows a precise cut and a high working speed.

1. A method for severing a protruding portion of a layer of a laminate, in particular a backing film of a laminate that comprises at least one solid plate, in particular a glass plate, a severing tool, having a rotating cutting knife and a rotating counter-knife, being used, the knives being made to rotate in opposite directions about parallel axes, and the cutting knife and the counter-knife being offset laterally in such a way that a main surface of the cutting knife contacts a main surface of the counter-knife in a working region.

2. The method as claimed in claim 1, whereas the cutting knife and the counter-knife are advanced to one another in such a way that they are biased against one another in the axial direction.

3. The method as claimed in claim 1, whereas rotary motions of the cutting knife and of the counter-knife, and a relative motion between the severing tool and the laminate, are controlled in such a way that a peripheral region of the knives is substantially stationary relative to the protruding portion during the severing operation.

4. The method as claimed in claim 1, for machining a laminate that comprises at least one solid plate, the method comprising the following steps:
c) before a laminating step, applying at least one location marking to the solid plate, and determination of at least one distance value and/or angle value of the solid plate in relation to the location marking;
d) after the laminating step, severing the protruding portion, the laminate and the severing tool being positioned automatically relative to one another in dependence on the location marking and the at least one distance value and/or angle value.

5. A severing tool for severing a protruding portion of a layer of a laminate, in particular a backing film of a laminate that comprises at least one solid plate, in particular a glass plate, comprising
a) a rotating cutting knife,
b) a rotating counter-knife,
c) at least one drive means for rotatably driving the cutting knife and the counter-knife,
wherein
d) the cutting knife and the counter-knife are mounted about parallel rotational axes,
e) the cutting knife and the counter-knife can be driven in opposite directions, and wherein
f) the cutting knife and the counter-knife are laterally offset in such a way that a main surface of the cutting knife contacts a main surface of the counter-knife in a working region.

6. The severing tool as claimed in claim 5, whereas the rotational axes of the cutting knife and of the counter-knife are arranged in such a way that a plane running through the two rotational axes runs obliquely in relation to a working direction, an angle between this plane and the working direction preferably being 55-85°, particularly preferably 65-80°.

7. The severing tool as claimed in claim 5, whereas the rotational axis of the cutting knife and/or the rotational axis of the counter-knife is/are realized so as to be adjustable, in particular automatically adjustable, in such a way that a distance of the rotational axis of the cutting knife and of the rotational axis of the counter-knife is adjustable.

8. A machining station for severing a protruding portion of a layer of a laminate, in particular a backing film of a laminate that comprises at least one solid plate, in particular a glass plate, comprising at least one severing tool as claimed in claim 5.

9. The machining station as claimed in claim 8, comprising
a) a holding means, in particular a table, for holding the laminate
b) a linear unit, which can be moved along the laminate held in the holding means,
c) a severing head, on which the cutting knife and the counter-knife are arranged, the severing head being mounted on the linear unit.

10. The machining station as claimed in claim 9, whereas the severing head is movably mounted on the linear unit in such a way that it can be moved horizontally in a direction perpendicular to the direction of motion of the linear unit.

11. The machining station as claimed in claim 9, whereas the severing head is realized in such a way that the cutting knife and the counter-knife are mounted, in respect of the linear unit, so as to be rotatable about an axis that is perpendicular to a main surface of the laminate to be machined.

12. The machining station as claimed in claim 11, whereas the severing head has at least two servo drives, which, via coaxial shafts, effect driving of the cutting knife and of the counter-knife and effect an adjustment of the rotational position of the cutting knife and of the counter-knife.

13. The machining station as claimed in claim 12, characterized by a third servo drive, which, via a further coaxial shaft, allows a relative adjustment of the rotational axis of the cutting knife and of the rotational axis of the counter-knife.

14. The machining station as claimed in claim 8, characterized by a sharpening station, which is arranged in such a way that it can be automatically started by the severing head for the purpose of sharpening the cutting knife and the counter-knife.

15. An installation for machining a laminate that comprises at least one solid plate, in particular a glass plate, comprising:
e) a marking station for applying a location marking to the solid plate;
f) a measuring station for determining at least one distance value and/or angle value of the solid plate in relation to the location marking;
g) a laminating station for laminating the laminate, which laminating station is arranged after the marking station and the measuring station; and
h) a machining station as claimed in claim 8, the severing tool and the laminate being automatically positionable relative to one another in dependence on the location marking and the at least one distance value and/or angle value.

16. A machining station for severing a protruding portion of a layer of a laminate, in particular a backing film of a laminate that comprises at least one solid plate, in particular a glass plate, comprising at least one severing tool as claimed in claim 6.

17. A machining station for severing a protruding portion of a layer of a laminate, in particular a backing film of a laminate that comprises at least one solid plate, in particular a glass plate, comprising at least one severing tool as claimed in claim 7.
